(19) United States
(12) Patent Application Publication
(10) Pub. No.: US 2016/0037774 A1
(43) Pub. Date: Feb. 11, 2016

(54) SYNERGISTIC FUNGICIDAL MIXTURES FOR FUNGAL CONTROL IN CEREALS

(71) Applicant: DOW AGROSCIENCES LLC, Indianapolis, IN (US)

(72) Inventor: Thomas Schulz, Niederschoena (DE)

(21) Appl. No.: 14/818,945

(22) Filed: Aug. 5, 2015

Related U.S. Application Data
(60) Provisional application No. 62/035,198, filed on Aug. 8, 2014.

(51) Int. Cl. A01N 43/40; A01N 43/653

(52) U.S. Cl. CPC A01N 43/40; A01N 43/653

(57) ABSTRACT

A fungicidal composition containing a fungicidally effective amount of a compound of Formula I, (3S,6S,7R,8R)-8-benzyl-3-(3-((isobutyryloxy)methoxy)-4-methoxypicolinamido)-6-methyl-4,9-dioxo-1,5-dioxonan-7-yl isobutyrate, and at least one fungicide selected from the group consisting of prothioconazole, epoxiconazole, cyproconazole, myclobutanil, prochloraz, metconazole, difenconazole, tebuconazole, tetraconazole, fenbuconazole, propiconazole, fluquinconazole, flusilazole, flutriafol, and fenpropimorph.

### CROSS REFERENCE TO RELATED APPLICATIONS

This application claims the benefit of U.S. Provisional Patent Application Ser. No. 62/035,198 filed Aug. 8, 2014, which is expressly incorporated by reference herein.

### FIELD

This disclosure concerns a synergistic fungicidal composition containing (a) a compound of Formula I, (3S,6S,7R,8R)-8-benzyl-3-(3-((isobutyryloxy)methoxy)-4-methoxypicolinamido)-6-methyl-4,9-dioxo-1,5-dioxonan-7-yl isobutyrate, and (b) at least one ergosterol biosynthesis-inhibitor fungicide selected from the group consisting of prothioconazole, epoxiconazole, cyproconazole, myclobutanil, prochloraz, metconazole, difenconazole, tebuconazole, tetraconazole, fenbuconazole, propiconazole, fluquinconazole, flusilazole, flutriafol, and fenpropimorph.

### BACKGROUND

Fungicides are compounds, of natural or synthetic origin, which act to protect plants against damage caused by fungi. Current methods of agriculture rely heavily on the use of fungicides. In fact, some crops cannot be grown usefully without the use of fungicides. Using fungicides allows a grower to increase the yield and the quality of the crop, and consequently, increase the value of the crop. In most situations, the increase in value of the crop is worth at least three times the cost of the use of the fungicide.

However, no one fungicide is useful in all situations and repeated usage of a single fungicide frequently leads to the development of resistance to that and related fungicides. Consequently, research is being conducted to produce fungicides and combinations of fungicides that are safer, that have better performance, that require lower dosages, that are easier to use, and that cost less.

Synergism occurs when the effect of two or more compounds exceeds the effect of the compounds when used alone.

### SUMMARY

It is an object of this disclosure to provide synergistic compositions comprising fungicidal compounds. It is a further object of this disclosure to provide processes that use these synergistic compositions. The synergistic compositions are capable of preventing or curing, or both, diseases caused by fungi of the classes Ascomycetes and Basidiomycetes. In addition, the synergistic compositions are capable of providing improved growth in crops, wherein the growth improvement is characterized by at least one of the effects selected from the group consisting of preventing or curing pathogenic fungi and improving plant physiology, wherein improved plant physiology is characterized by at least one of the effects selected from the group consisting of enhanced root growth, improved greening, improved water use and efficiency, improved nitrogen use efficiency, delayed senescence, and enhanced yield. In accordance with this disclosure, synergistic compositions are provided along with methods for their use.

### DETAILED DESCRIPTION

The present disclosure concerns a synergistic fungicidal mixture comprising an fungicidally effective amount of (a) a compound of Formula I, (3S,6S,7R,8R)-8-benzyl-3-(3-((isobutyryloxy)methoxy)-4-methoxypicolinamido)-6-methyl-4,9-dioxo-1,5-dioxonan-7-yl isobutyrate, and (b) at least one ergosterol biosynthesis-inhibitor fungicide selected from the group consisting of prothioconazole, epoxiconazole, cyproconazole, myclobutanil, prochloraz, metconazole, difenconazole, tebuconazole, tetraconazole, fenbuconazole, propiconazole, fluquinconazole, flusilazole, flutriafol, and fenpropimorph.

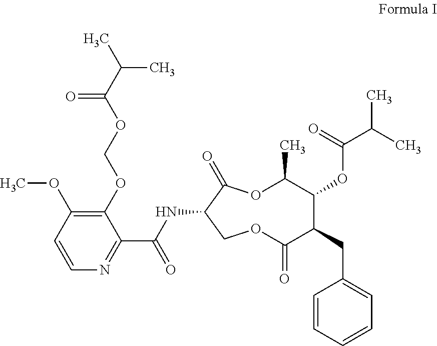 [SMILES: COc1ccnc(C(=O)N[C@H]2COC(=O)[C@H](Cc3ccccc3)[C@@H](OC(=O)C(C)C)[C@H](C)OC2=O)c1OCOC(=O)C(C)C]

As used herein, prothioconazole is the common name 2-[(2RS)-2-(1-chlorocyclopropyl)-3-(2-chlorophenyl)-2-hydroxypropyl]-2H-1,2,4-triazole-3(4H)-thione and possesses the following structure:

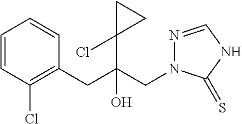 [SMILES: OC(Cc1ccccc1Cl)(Cn1nc[nH]c1=S)C1(Cl)CC1]

Its fungicidal activity is described in The Pesticide Manual, Fifteenth Edition, 2009. Prothioconazole provides control of diseases such as eyespot (Pseudocercosporella herpotrichoides), Fusarium ear blight (Fusarium spp., Microdochium nivale), leaf blotch diseases (Septoria tritici, Leptosphaeria nodorum, Pyrenophora spp., Rhynchosporium secalis, etc.), rust (Puccinia spp.) and powdery mildew (Blumeria graminis), by foliar application, in wheat, barley and other crops.

In the compositions described herein, the weight ratios of the compound of Formula I at which the synergistic effects with the other fungicides are observed lie within the range of about 1:10 and 10:1.

In one embodiment, the weight ratio of the compound of Formula I to the other fungicides at which the fungicidal effect is synergistic lies within the range of between about 1:5 and about 5:1 and in another embodiment, the weight ratio lies within the range of between about 1:2 and about 1:1, and in still another embodiment, the weight ratio lies within the range of about 100:195 and about 130:195. In yet another embodiment, the weight ratios described herein are given for a compound of Formula I and other fungicides, wherein prothioconazole is representative of the other fungicides.

In the compositions described herein, the weight ratio of the compound of Formula I at which the improved plant physiology is synergistic, wherein improved plant physiology is characterized by at least one of the effects selected from the group consisting of enhanced root growth, improved greening, improved water use and efficiency, improved nitrogen use efficiency, delayed senescence, and enhanced yield, to the other fungicides lies within the range of about 1:10 and about 10:1.

In one embodiment, the weight ratio of the compound of Formula I to the other fungicides at which the improved plant physiology effect is synergistic, wherein the improved plant physiology effect is enhanced yield, lies within the range of about 1:5 and about 5:1 and in another embodiment, the weight ratio of the compound of Formula I at which the synergistic yield enhancement is observed with the other fungicides lies within the range of about 1:2 and about 1:1. In one embodiment, the weight ratio of the compound of Formula I to the other fungicides at which the improved plant physiology effect is synergistic, wherein the improved plant physiology effect is characterized by increased greening of plant tissue, lies within the range of about 1:5 and about 5:1 and in another embodiment, the weight ratio of the compound of Formula I at which the greening effect is observed with the other fungicides lies within the range of about 1:2 and about 1:1. In yet another embodiment, the weight ratios described herein are given for a compound of Formula I and other fungicides, wherein prothioconazole is representative of the other fungicides.

The rate at which the synergistic composition is applied will depend upon the particular type of fungus to be controlled, the degree of control required and the timing and method of application. In general, the composition of the disclosure can be applied at an application rate of between about 25 grams per hectare (g/ha) and about 850 g/ha based on the total amount of active ingredients in the composition.

The synergistic composition comprising the compound of Formula I and prothioconazole is applied at a rate between about 60 g/ha and about 600 g/ha. Prothioconazole is applied at a rate between about 25 g/ha and about 300 g/ha and the compound of Formula I is applied at a rate between about 35 g/ha and about 300 g/ha. In a more particular embodiment, prothioconazole is applied at a rate between about 100 g/ha and 200 g/ha, even more particularly about 195 g/ha, and the compound of Formula 1 is applied at a rate between about 75 g/ha and 150 g/ha, even more particularly between about 100 g/ha and 130 g/ha.

The components of the synergistic mixture of the present disclosure can be applied either separately or as part of a multipart fungicidal system.

The synergistic mixture of the present disclosure can be applied in conjunction with one or more other fungicides to control a wider variety of undesirable diseases. When used in conjunction with other fungicide(s), the presently claimed compounds may be formulated with the other fungicide(s), tank mixed with the other fungicide(s) or applied sequentially with the other fungicide(s). Such other fungicides may include 2-(thiocyanatomethylthio)-benzothiazole, 2-phenylphenol, 8-hydroxyquinoline sulfate, ametoctradin, amisulbrom, antimycin, Ampelomyces quisqualis, azaconazole, azoxystrobin, Bacillus subtilis, Bacillus subtilis strain QST713, benalaxyl, benomyl, benthiavalicarb-isopropyl, benzylaminobenzene-sulfonate (BABS) salt, bicarbonates, biphenyl, bismerthiazol, bitertanol, bixafen, blasticidin-S, borax, Bordeaux mixture, boscalid, bromuconazole, bupirimate, calcium polysulfide, captafol, captan, carbendazim, carboxin, carpropamid, carvone, chlazafenone, chloroneb, chlorothalonil, chlozolinate, Coniothyrium minitans, copper hydroxide, copper octanoate, copper oxychloride, copper sulfate, copper sulfate (tribasic), cuprous oxide, cyazofamid, cyflufenamid, cymoxanil, cyproconazole, cyprodinil, dazomet, debacarb, diammonium ethylenebis-(dithiocarbamate), dichlofluanid, dichlorophen, diclocymet, diclomezine, dichloran, diethofencarb, difenoconazole, difenzoquation, diflumetorim, dimethomorph, dimoxystrobin, diniconazole, diniconazole-M, dinobuton, dinocap, diphenylamine, dithianon, dodemorph, dodemorph acetate, dodine, dodine free base, edifenphos, enestrobin, enestroburin, epoxiconazole, ethaboxam, ethoxyquin, etridiazole, famoxadone, fenamidone, fenarimol, fenbuconazole, fenfuram, fenhexamid, fenoxanil, fenpiclonil, fenpropidin, fenpropimorph, fenpyrazamine, fentin, fentin acetate, fentin hydroxide, ferbam, ferimzone, fluazinam, fludioxonil, flumorph, fluopicolide, fluopyram, fluoroimide, fluoxastrobin, fluquinconazole, flusilazole, flusulfamide, flutianil, flutolanil, flutriafol, fluxapyroxad, folpet, formaldehyde, fosetyl, fosetyl-aluminium, fuberidazole, furalaxyl, furametpyr, guazatine, guazatine acetates, GY-81, hexachlorobenzene, hexaconazole, hymexazol, imazalil, imazalil sulfate, imibenconazole, iminoctadine, iminoctadine triacetate, iminoctadine tris(albesilate), iodocarb, ipconazole, ipfenpyrazolone, iprobenfos, iprodione, iprovalicarb, isoprothiolane, isopyrazam, isotianil, kasugamycin, kasugamycin hydrochloride hydrate, kresoxim-methyl, laminarin, mancopper, mancozeb, mandipropamid, maneb, mefenoxam, mepanipyrim, mepronil, meptyl-dinocap, mercuric chloride, mercuric oxide, mercurous chloride, metalaxyl, metalaxyl-M, metam, metam-ammonium, metam-potassium, metam-sodium, metconazole, methasulfocarb, methyl iodide, methyl isothiocyanate, metiram, metominostrobin, metrafenone, mildiomycin, myclobutanil, nabam, nitrothal-isopropyl, nuarimol, octhilinone, ofurace, oleic acid (fatty acids), orysastrobin, oxadixyl, oxine-copper, oxpoconazole fumarate, oxycarboxin, pefurazoate, penconazole, pencycuron, penflufen, pentachlorophenol, pentachlorophenyl laurate, penthiopyrad, phenylmercury acetate, phosphonic acid, phthalide, picoxystrobin, polyoxin B, polyoxins, polyoxorim, potassium bicarbonate, potassium hydroxyquinoline sulfate, probenazole, prochloraz, procymidone, propamocarb, propamocarb hydrochloride, propiconazole, propineb, proquinazid, prothioconazole, pyraclostrobin, pyrametostrobin, pyraoxystrobin, pyrazophos, pyribencarb, pyributicarb, pyrifenox, pyrimethanil, pyriofenone, pyroquilon, quinoclamine, quinoxyfen, quintozene, Reynoutria sachalinensis extract, sedaxane, silthiofam, simeconazole, sodium 2-phenylphenoxide, sodium bicarbonate, sodium pentachlorophenoxide, spiroxamine, sulfur, SYP-Z048, tar oils, tebuconazole, tebufloquin, tecnazene, tetraconazole, thiabendazole, thifluzamide, thiophanate-methyl, thiram, tiadinil, tolclofos-methyl, tolylfluanid, triadimefon, triadimenol, triazoxide, tricyclazole, tridemorph, trifloxystrobin, triflumizole, triforine, triticonazole, validamycin, valifenalate, valiphenal, vinclozolin, zineb, ziram, zoxamide, Candida oleophila, Fusarium oxysporum, Gliocladium spp., Phlebiopsis gigantea, Streptomyces griseoviridis, Trichoderma spp., (RS)—N-(3,5-dichlorophenyl)-2-(methoxymethyl)-succinimide, 1,2-dichloropropane, 1,3-dichloro-1,1,3,3-tetrafluoroacetone hydrate, 1-chloro-2,4-dinitronaphthalene, 1-chloro-2-nitropropane, 2-(2-heptadecyl-2-imidazolin-1-yl)ethanol, 2,3-dihydro-5-phenyl-1,4-dithi-ine 1,1,4,4-tetraoxide, 2-methoxyethylmercury acetate, 2-methoxyethylmercury chloride, 2-methoxyethylmercury silicate, 3-(4-chlorophenyl)-5-methylrhodanine, 4-(2-nitroprop-1-enyl)phenyl thiocyanateme, ampropylfos, anilazine, azithiram, barium polysulfide, Bayer 32394, benodanil, benquinox, bentaluron, benzamacril; benzamacril-isobutyl, benzamorf, binapacryl, bis(methylmercury) sulfate, bis(tributyltin) oxide, buthiobate, cadmium calcium copper zinc chromate sulfate, carbamorph, CECA, chlobenthiazone, chloraniformethan, chlorfenazole, chlorquinox, climbazole, copper bis(3-phenylsalicylate), copper zinc chromate, cufraneb, cupric hydrazinium sulfate, cuprobam, cyclafuramid, cypendazole, cyprofuram, decafentin, dichlone, dichlozoline, diclobutrazol, dimethirimol, dinocton, dinosulfon, dinoterbon, dipyrithione, ditalimfos, dodicin, drazoxolon, EBP, ESBP, etaconazole, etem, ethirim, fenaminosulf, fenapanil, fenitropan, fluotrimazole, furcarbanil, furconazole, furconazole-cis, furmecyclox, furophanate, glyodine, griseofulvin, halacrinate, Hercules 3944, hexylthiofos, ICIA0858, isopamphos, isovaledione, mebenil, mecarbinzid, metazoxolon, methfuroxam, methylmercury dicyandiamide, metsulfovax, milneb, mucochloric anhydride, myclozolin, N-3,5-dichlorophenyl-succinimide, N-3-nitrophenylitaconimide, natamycin, N-ethylmercurio-4-toluenesulfonanilide, nickel bis(dimethyldithiocarbamate), OCH, phenylmercury dimethyldithiocarbamate, phenylmercury nitrate, phosdiphen, prothiocarb; prothiocarb hydrochloride, pyracarbolid, pyridinitril, pyroxychlor, pyroxyfur, quinacetol; quinacetol sulfate, quinazamid, quinconazole, rabenzazole, salicylanilide, SSF-109, sultropen, tecoram, thiadifluor, thicyofen, thiochlorfenphim, thiophanate, thioquinox, tioxymid, triamiphos, triarimol, triazbutil, trichlamide, urbacid, zarilamid, and any combinations thereof.

The compositions of the present disclosure are preferably applied in the form of a formulation comprising a composition of (a) a compound of Formula I and (b) at least one ergosterol biosynthesis-inhibitor fungicide selected from the group consisting of prothioconazole, epoxiconazole, cyproconazole, myclobutanil, prochloraz, metconazole, difenconazole, tebuconazole, tetraconazole, fenbuconazole, propiconazole, fluquinconazole, flusilazole, flutriafol, and fenpropimorph, together with a phytologically acceptable carrier.

Concentrated formulations can be dispersed in water, or another liquid, for application, or formulations can be dust-like or granular, which can then be applied without further treatment. The formulations are prepared according to procedures which are conventional in the agricultural chemical art, but which are novel and important because of the presence therein of a synergistic composition.

The formulations that are applied most often are aqueous suspensions or emulsions. Either such water-soluble, water-suspendable, or emulsifiable formulations are solids, usually known as wettable powders, or liquids, usually known as emulsifiable concentrates, aqueous suspensions, or suspension concentrates. The present disclosure contemplates all vehicles by which the synergistic compositions can be formulated for delivery and use as a fungicide.

As will be readily appreciated, any material to which these synergistic compositions can be added may be used, provided they yield the desired utility without significant interference with the activity of these synergistic compositions as antifungal agents.

Wettable powders, which may be compacted to form water-dispersible granules, comprise an intimate mixture of the synergistic composition, a carrier and agriculturally acceptable surfactants. The concentration of the synergistic composition in the wettable powder is usually from about 10% to about 90% by weight, more preferably about 25% to about 75% by weight, based on the total weight of the formulation. In the preparation of wettable powder formulations, the synergistic composition can be compounded with any of the finely divided solids, such as prophyllite, talc, chalk, gypsum, Fuller's earth, bentonite, attapulgite, starch, casein, gluten, montmorillonite clays, diatomaceous earths, purified silicates or the like. In such operations, the finely divided carrier is ground or mixed with the synergistic composition in a volatile organic solvent. Effective surfactants, comprising from about 0.5% to about 10% by weight of the wettable powder, include sulfonated lignins, naphthalenesulfonates, alkylbenzenesulfonates, alkyl sulfates, and non-ionic surfactants, such as ethylene oxide adducts of alkyl phenols.

Emulsifiable concentrates of the synergistic composition comprise a convenient concentration, such as from about 10% to about 50% by weight, in a suitable liquid, based on the total weight of the emulsifiable concentrate formulation. The components of the synergistic compositions, jointly or separately, are dissolved in a carrier, which is either a water-miscible solvent or a mixture of water-immiscible organic solvents, and emulsifiers. The concentrates may be diluted with water and oil to form spray mixtures in the form of oil-in-water emulsions. Useful organic solvents include aromatics, especially the high-boiling naphthalenic and olefinic portions of petroleum such as heavy aromatic naphtha. Other organic solvents may also be used, such as, for example, terpenic solvents, including rosin derivatives, aliphatic ketones, such as cyclohexanone, and complex alcohols, such as 2-ethoxyethanol.

Emulsifiers which can be advantageously employed herein can be readily determined by those skilled in the art and include various nonionic, anionic, cationic and amphoteric emulsifiers, or a blend of two or more emulsifiers. Examples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers and appropriate salts of phosphated polyglycol ether.

Representative organic liquids which can be employed in preparing the emulsifiable concentrates of the present disclosure are the aromatic liquids such as xylene, propyl benzene fractions, or mixed naphthalene fractions, mineral oils, substituted aromatic organic liquids such as dioctyl phthalate, kerosene, dialkyl amides of various fatty acids, particularly the dimethyl amides of fatty glycols and glycol derivatives such as the n-butyl ether, ethyl ether or methyl ether of diethylene glycol, and the methyl ether of triethylene glycol. Mixtures of two or more organic liquids are also often suitably employed in the preparation of the emulsifiable concentrate. The preferred organic liquids are xylene, and propyl benzene fractions, with xylene being most preferred. The surface-active dispersing agents are usually employed in liquid formulations and in the amount of from 0.1 to 20 percent by weight of the combined weight of the dispersing agent with the synergistic compositions. The formulations can also contain other compatible additives, for example, plant growth regulators and other biologically active compounds used in agriculture.

Aqueous suspensions comprise suspensions of one or more water-insoluble compounds, dispersed in an aqueous vehicle at a concentration in the range from about 5% to about 70% by weight, based on the total weight of the aqueous suspension formulation. Suspensions are prepared by finely grinding the components of the synergistic combination either together or separately, and vigorously mixing the ground material into a vehicle comprised of water and surfactants chosen from the same types discussed above. Other ingredients, such as inorganic salts and synthetic or natural gums, may also be added to increase the density and viscosity of the aqueous vehicle. It is often most effective to grind and mix at the same time by preparing the aqueous mixture and homogenizing it in an implement such as a sand mill, ball mill, or piston-type homogenizer.

The synergistic composition may also be applied as a granular formulation, which is particularly useful for applications to the soil. Granular formulations usually contain from about 0.5% to about 10% by weight of the compounds, based on the total weight of the granular formulation, dispersed in a carrier which consists entirely or in large part of coarsely divided attapulgite, bentonite, diatomite, clay or a similar inexpensive substance. Such formulations are usually prepared by dissolving the synergistic composition in a suitable solvent and applying it to a granular carrier which has been preformed to the appropriate particle size, in the range of from about 0.5 to about 3 mm. Such formulations may also be prepared by making a dough or paste of the carrier and the synergistic composition, and crushing and drying to obtain the desired granular particle.

Dusts containing the synergistic composition are prepared simply by intimately mixing the synergistic composition in powdered form with a suitable dusty agricultural carrier, such as, for example, kaolin clay, ground volcanic rock, and the like. Dusts can suitably contain from about 1% to about 10% by weight of the synergistic composition/carrier combination.

The formulations may contain agriculturally acceptable adjuvant surfactants to enhance deposition, wetting and penetration of the synergistic composition onto the target crop and organism. These adjuvant surfactants may optionally be employed as a component of the formulation or as a tank mix. The amount of adjuvant surfactant will vary from 0.01 percent to 1.0 percent volume/volume (v/v) based on a spray-volume of water, preferably 0.05 to 0.5 percent. Suitable adjuvant surfactants include ethoxylated nonyl phenols, ethoxylated synthetic or natural alcohols, salts of the esters or sulfosuccinic acids, ethoxylated organosilicones, ethoxylated fatty amines and blends of surfactants with mineral or vegetable oils.

The formulations may optionally include combinations that can comprise at least 1% by weight of one or more of the synergistic compositions with another pesticidal compound. Such additional pesticidal compounds may be fungicides, insecticides, nematocides, miticides, arthropodicides, bactericides or combinations thereof that are compatible with the synergistic compositions of the present disclosure in the medium selected for application, and not antagonistic to the activity of the present compounds. Accordingly, in such embodiments the other pesticidal compound is employed as a supplemental toxicant for the same or for a different pesticidal use. The pesticidal compound and the synergistic composition can generally be mixed together in a weight ratio of from 1:100 to 100:1.

The present disclosure includes within its scope methods for the control or prevention of fungal attack and methods for providing improved plant physiology, wherein improved plant physiology is characterized by at least one of the effects selected from the group consisting of enhanced root growth, improved greening, improved water use and efficiency, improved nitrogen use efficiency, delayed senescence, and enhanced yield. These methods comprise applying to the locus of the fungus, or to a locus in which the infestation is to be prevented (for example applying to wheat or barley plants), a fungicidally effective amount of the synergistic composition. The synergistic composition is suitable for treatment of various plants at fungicidal levels, while exhibiting low phytotoxicity. The synergistic composition is useful in a protectant or eradicant fashion. The synergistic composition is applied by any of a variety of known techniques, either as the synergistic composition or as a formulation comprising the synergistic composition. For example, the synergistic compositions may be applied to the roots, seeds or foliage of plants for the control of various fungi, without damaging the commercial value of the plants. The synergistic composition is applied in the form of any of the generally used formulation types, for example, as solutions, dusts, wettable powders, flowable concentrates, or emulsifiable concentrates. These materials are conveniently applied in various known fashions.

The synergistic composition has been found to have significant fungicidal effect, particularly for agricultural use. Additionally, the synergistic composition has been found to promote improved plant physiology, wherein improved plant physiology is characterized by improved greening and enhanced yield. The synergistic composition is particularly effective for use with agricultural crops and horticultural plants, or with wood, paint, leather or carpet backing.

In particular, the synergistic composition is effective in controlling a variety of undesirable fungi that infect useful plant crops. The synergistic composition may be used against a variety of Ascomycete and Basidiomycete fungi, including for example the following representative fungi species: wheat brown rust (Puccinia recondita; Bayer code PUCCRT); stripe rust of wheat (Puccinia striiformis; Bayer code PUCCST); leaf blotch of wheat (Mycosphaerella graminicola; anamorph: Septoria tritici; Bayer code SEPTTR); glume blotch of wheat (Leptosphaeria nodorum; Bayer code LEPTNO; anamorph: Stagonospora nodorum); leaf blotch of barley (Rhynchosporium secalis; Bayer code RHYNSE), spot blotch of barley (Cochliobolus sativum; Bayer code COCHSA; anamorph: Helminthosporium sativum); leaf spot of sugar beets (Cercospora beticola; Bayer code CERCBE); leaf spot of peanut (Mycosphaerella arachidis; Bayer code MYCOAR; anamorph: Cercospora arachidicola); cucumber anthracnose (Glomerella lagenarium; anamorph: Colletotrichum lagenarium; Bayer code COLLLA). It will be understood by those in the art that the efficacy of the synergistic compositions for one or more of the foregoing fungi establishes the general utility of the synergistic compositions as fungicides.

The synergistic compositions have a broad range of efficacy as a fungicide. The exact amount of the synergistic composition to be applied is dependent not only on the relative amounts of the components, but also on the particular action desired, the fungal species to be controlled, and the stage of growth thereof, as well as the part of the plant or other product to be contacted with the synergistic composition. Thus, formulations containing the synergistic composition may not be equally effective at similar concentrations or against the same fungal species.

The synergistic compositions are effective in use with plants in a disease-inhibiting and phytologically acceptable amount. The term “disease-inhibiting and phytologically acceptable amount” refers to an amount of the synergistic composition that kills or inhibits the plant disease for which control is desired, but is not significantly toxic to the plant. The exact concentration of synergistic composition required varies with the fungal disease to be controlled, the type of formulation employed, the method of application, the particular plant species, climate conditions, and the like.

The present compositions can be applied to fungi or their locus by the use of conventional ground sprayers, granule applicators, and by other conventional means known to those skilled in the art.

The following examples are provided to further illustrate the disclosure. They are not meant to be construed as limiting the disclosure.

### Examples

### Evaluation of Improved Plant Physiology Including Yield Enhancement and Improved Greening of Fungicide Mixtures Vs. Leaf Blotch of Barley (Rhynchosporium Secalis; Bayer Code RHYNSE)

The results in Tables 1-3 were generated using foliar applied applications in small plot (2.5×8.0 meters (m)) research experiments to evaluate the compositions in winter barley (Hordeum vulgare, HORVW). Two treatments were applied at crop stages BBCH 31 and 43-49, respectively. Applications were made using a backpack sprayer (250 kPa) equipped with a 2.5 m spray boom fitted with 5 Agrotop-AM11002 flat fan nozzles spaced at 50 centimeters (cm) oriented at 90 degrees. The output volume of the compositions, diluted in water, was 200 liters per hectare (L/ha). Visual assessments for the control of leaf blotch of barley (Rhynchosporium secalis, RHYNSE) were reported as percent (%) infected leaf area and were conducted at the time of application 1 (untreated check at BBCH 31), at the time of application 2 (BBCH 43-49), and at 2-4 weeks after application 2. Improved plant health was measured through the visual assessment of % green leaf area 6 weeks after application 2 at growth stage BBCH 75-77. The values reported are means from 4 replicates and statistical differences were determined using Duncan's New MRT (P=0.5).

Colby's equation was used to determine the fungicidal effects expected from the mixtures. (See Colby, S. R. Calculation of the synergistic and antagonistic response of herbicide combinations. Weeds 1967, 15, 20-22.)

The following equation was used to calculate the expected activity of mixtures containing two active ingredients, A and B:

Expected=A+B−(A×B/100)
A=observed efficacy of active component A at the same concentration as used in the mixture;
B=observed efficacy of active component B at the same concentration as used in the mixture.

The ability of the compositions described herein to afford suitable disease control is illustrated by the efficacy data in Table 1 and representative synergistic interactions of the compositions with regard to increased yield and improved plant health are presented in Tables 2-3, respectively.

TABLE 1
Biological Activity Observed with Synergistic Mixtures of Compounds
of Formula I and Prothioconazole in Applications on Winter Barley
(Hordeum vulgare, HORVW) to Control Leaf Blotch of Barley
(Rhynchosporium secalis; Bayer code RHYNSE).

| | | | % Reduction |
|---|---|---|---|
| | Rates | Visible | of Visible |
| Composition | (g ai/ha)* | Lesions | Lesions* |
| Cmpd. I + Prothioconazole | 0.0 + 195.0 | 1.2 | 85.7 |
| Cmpd. I + Prothioconazole | 100.0 + 195.0 | 1.7 | 79.8 |
| Cmpd. I + Prothioconazole | 130.0 + 195.0 | 1.5 | 82.1 |
| Cmpd. I + Prothioconazole | 100.0 + 0.0 | 2.9 | 65.4 |
| Cmpd. I + Prothioconazole | 130.0 + 0.0 | 2.7 | 67.8 |
| Cmpd. I + Prothioconazole | 0.0 + 0.0 | 8.4 | — |

*g ai/h = grams active ingredient/hectare.
*% Reduction of Visible Lesions = (Visible Lesions on the Untreated − Visible Lesions on the Treated)/Visible Lesions on the Untreated × 100.

TABLE 2
Yield Improvement Observed with Synergistic Mixtures of Compounds
of Formula I and Prothioconazole in Applications on Winter Barley
(Hordeum vulgare, HORVW) to Control Leaf Blotch of Barley
(Rhynchosporium secalis; Bayer code RHYNSE).

| | | Increase in | | |
|---|---|---|---|---|
| | | Yield Ratio of | | |
| | | Treated:Untreated* | | |
| | Rates | (Raw Yield Data)* | | Synergy |
| Composition | (g ai/ha) | Observed | Expected | Factor* |
| Cmpd. I + | 0.0 + 195.0 | 8.3% | — | — |
| Prothioconazole | | (5.77) | | |
| Cmpd. I + | 100.0 + 195.0 | 13.2% | 8.5% | 1.55 |
| Prothioconazole | | (6.02) | | |
| Cmpd. I + | 130.0 + 195.0 | 15.7% | 11.2% | 1.40 |
| Prothioconazole | | (6.15) | | |
| Cmpd. I + | 100.0 + 0.0 | 0.2% | — | — |
| Prothioconazole | | (5.33) | | |
| Cmpd. I + | 130.0 + 0.0 | 3.2% | — | — |
| Prothioconazole | | (5.49) | | |

| | | | |
|---|---|---|---|
| Untreated | — | 100% | — |
| | | (5.32) | |

*g ai/h = grams active ingredient/hectare.
*% Increase in Yield Ratio of Treated:Untreated* = (Observed Yield/Untretaed Yield) × 100 − 100.
*Synergy Factor = Observed % Yield Increase/Expected % Yield Increase.
*Observed Raw Yield Data Is Measured in Metric Tons/Hectare (t/ha).

TABLE 3
Plant Greening Improvements Observed with Synergistic Mixtures
of Compounds of Formula I and Prothioconazole in Applications on
Winter Barley (Hordeum vulgare, HORVW) to Control Leaf Blotch
of Barley (Rhynchosporium secalis; Bayer code RHYNSE).

| | | Increase in % Green | | |
|---|---|---|---|---|
| | | Leaftop Ratio of | | |
| | | Treated:Untreated* | | |
| | Rates | (Raw % Green Leaftop) | | Synergy |
| Composition | (g ai/ha)* | Observed | Expected | Factor* |
| Cmpd. I + | 0.0 + 195.0 | 153.3% | — | — |
| Prothioconazole | | (76%) | | |
| Cmpd. I + | 100.0 + 195.0 | 183.3% | 153.3% | 1.2 |
| Prothioconazole | | (85%) | (83.2%) | |
| Cmpd. I + | 130.0 + 195.0 | 200% | 142.6% | 1.4 |
| Prothioconazole | | (90%) | (84.6%) | |
| Cmpd. I + | 100.0 + 0.0 | 0% | — | — |
| Prothioconazole | | (30%) | | |
| Cmpd. I + | 130.0 + 0.0 | 20% | — | — |
| Prothioconazole | | (36%) | | |

| | | | |
|---|---|---|---|
| Untreated | — | 100% | — |
| | | (30%) | |

*g ai/h = grams active ingredient/hectare.
*% Increase in % Green Leaftop Ratio of Treated:Untreated = (Observed % Green Leaftop/Untreated % Green Leaftop) × 100 − 100.
*Synergy Factor = Observed % Green Leaftop/Expected % Green Leaftop.

1. A synergistic mixture comprising a fungicidally effective amount of a compound of Formula I, (3S,6S,7R,8R)-8-benzyl-3-(3-((isobutyryloxy)methoxy)-4-methoxypicolinamido)-6-methyl-4,9-dioxo-1,5-dioxonan-7-yl isobutyrate, and at least one fungicidal sterol biosynthesis inhibitor, wherein the sterol biosynthesis inhibitor is selected from the group consisting of prothioconazole, epoxiconazole, cyproconazole, myclobutanil, prochloraz, metconazole, difenconazole, tebuconazole, tetraconazole, fenbuconazole, propiconazole, fluquinconazole, flusilazole, flutriafol, and fenpropimorph.

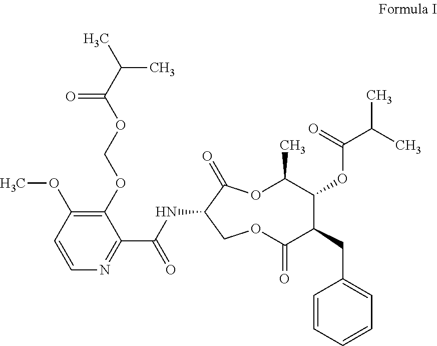 [SMILES: COc1ccnc(C(=O)N[C@H]2COC(=O)[C@H](Cc3ccccc3)[C@@H](OC(=O)C(C)C)[C@H](C)OC2=O)c1OCOC(=O)C(C)C]

2. The mixture according to claim 1, wherein the weight ratio of the compound of Formula I to the sterol biosynthesis inhibitor is between about 1:10 and about 10:1.

3. The mixture according to claim 2, wherein the sterol biosynthesis inhibitor is prothioconazole.

4. A synergistic composition for providing improved growth in crops comprising the mixtures according to claim 1 and a phytologically acceptable carrier material, wherein improved growth in crops is characterized by at least one of the effects selected from the group consisting of preventing or curing pathogenic fungi and improving plant physiology, wherein improved plant physiology is characterized by at least one of the effects selected from the group consisting of enhanced root growth, improved greening, improved water use and efficiency, improved nitrogen use efficiency, delayed senescence, and enhanced yield.

5. A composition according to claim 4, wherein improved growth is characterized by curing or preventing diseases caused by pathogenic fungi.

6. A composition according to claim 5, wherein the disease and pathogenic fungi are selected from the group consisting of wheat brown rust (Puccinia recondita; PUCCRT); stripe rust of wheat (Puccinia striiformis; PUCCST); leaf blotch of wheat (Mycosphaerella graminicola; anamorph: Septoria tritici; SEPTTR); glume blotch of wheat (Leptosphaeria nodorum; anamorph: Stagonospora nodorum); leaf blotch of barley (Rhynchosporium secalis; RHYNSE), spot blotch of barley (Cochliobolus sativum; COCHSA; anamorph: Helminthosporium sativum); leaf spot of sugar beets (Cercospora beticola; CERCBE); leaf spot of peanut (Mycosphaerella arachidis; MYCOAR; anamorph: Cercospora arachidicola); cucumber anthracnose (Glomerella lagenarium; anamorph: Colletotrichum lagenarium; COLLLA).

7. A composition according to claim 6, wherein the pathogen is Rhynchosporium secalis (RHYNSE), the causal agent of leaf blotch of barley.

8. A composition according to claim 4, wherein improved growth is characterized by improved plant physiology, wherein improved plant physiology is characterized by at least one of the effects selected from the group consisting of enhanced root growth, improved greening, improved water use and efficiency, improved nitrogen use efficiency, delayed senescence, and enhanced yield.

9. A composition according to claim 8, wherein the improved plant physiology is characterized by increased yield.

10. A composition according to claim 8, wherein the improved plant physiology is characterized by increased greening of plant tissue.

11. A method for improving growth in crops, the method comprising:
applying a fungicidally effective amount of a compound of Formula I 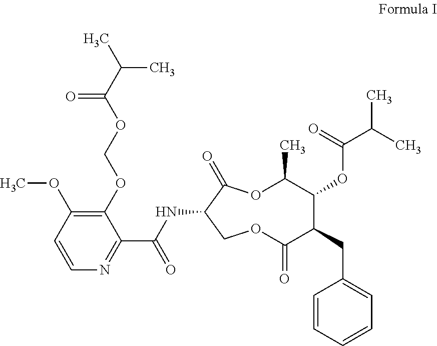 [SMILES: COc1ccnc(C(=O)N[C@H]2COC(=O)[C@H](Cc3ccccc3)[C@@H](OC(=O)C(C)C)[C@H](C)OC2=O)c1OCOC(=O)C(C)C]
and at least one fungicidal sterol biosynthesis inhibitor, wherein said effective amount is applied to at least one of the plant, an area adjacent to the plant, soil adapted to support growth of the plant, a root of the plant, and foliage of the plant.

12. A method according to claim 11 wherein the sterol biosynthesis inhibitor is prothioconazole.
